(19) United States
(12) Patent Application Publication
(10) Pub. No.: US 2010/0015286 A1
(43) Pub. Date: Jan. 21, 2010

(54) WATER BEVERAGE

(76) Inventors: Maziar Ghodsian, Newport Beach, CA (US); Andree Armand, Venice, CA (US)

Correspondence Address: PATENT INGENUITY, PC, 520 BROADWAY, SUITE 350, SANTA MONICA, CA, 90401, US

(21) Appl. No.: 12/177,081

(22) Filed: Jul. 21, 2008

(51) Int. Cl. A23L 2/58; A23L 2/38; A23L 2/46

(52) U.S. Cl. 426/66

(57) ABSTRACT

A process is provided. The process composes a solution that includes water and organic maltodextrin such that the organic maltodextrin is soluble in the water. Further, the process adds an organic compliant color to the solution such that eight fluid ounces of the solution is less than or equal to two and one half calories, and at least ninety five percent of a dry weight of the solution is organic substances. The organic compliant color includes at least one antioxidant. Finally, the process pasteurizes the solution.

### BACKGROUND

1. Field

This disclosure generally relates to the field of beverages. More particularly, the disclosure relates to a hydration beverage.

2. General Background

A number of hydration beverage products are currently in the marketplace. Drinking waters are an example of such hydration beverage products. Drinking waters may include mineral water, spring water, reverse osmosis water, vapor distilled water, purified water, and carbonated water. Electrolyte enhanced drinking water is another example. Electrolyte enhanced drinking water is typically a combination at least one salt, e.g., calcium, potassium, or magnesium, and at least one water source such as vapor distilled water, reverse osmosis water, purified water, or the like. Vitamin enhanced waters are yet another example. Vitamin enhanced waters typically include a variety of vitamins and minerals, flavors (natural, artificial or organic flavors), colors, and/or sweeteners. A preservative may also be utilized in the vitamin enhanced waters. Flavor enhanced waters are yet another example. Flavor enhanced waters typically include water (carbonated or still) and a flavor (a natural, artificial, or organic). The flavor may or may not include a natural, artificial, or organic color or sweetener. Sports drinks are yet another example. Sports drinks typically include electrolytes, a flavor, a sweetener (natural, artificial, or organic), a color, and a preservative. The electrolytes may be derived from sodium, potassium, or chloride. Various other beverages are also currently being marketed. Carbonated sodas, fruit juices, energy drinks, and a variety of other beverages also have water.

Further, some beverage products include antioxidants to help improve the health and potentially prevent diseases in individuals. For example, antioxidant enhanced waters are beverage products that typically include an antioxidant, a flavor (natural, organic or artificial flavor), and/or a sweetener. An antioxidant is a molecule that helps minimize or prevent oxidation of other molecules, which may damage cells. Examples of antioxidants include glutathione, vitamin C, and vitamin E. However, the antioxidant in the beverage products is typically synthetically derived from vitamins such as vitamin C or vitamin E. A preservative may also be utilized.

The antioxidant water beverage products currently on the market contain a synthetic antioxidant and a chemical preservative. By being synthetic, the antioxidant in these water beverage products is formulated or manufactured from a process, other than a naturally occurring biological process, that chemically changes a substance that is extracted form a naturally occurring plant, animal, or mineral source. Further, the chemical preservative is typically utilized to enhance the beverage products with flavors, carbohydrates, and other ingredients so to preserve shelf life. The chemical preservative also eradicates potential microorganisms. Pasteurization may be utilized alternatively or in conjunction with the chemical preservative to eradicate the potential microorganisms.

In addition, consumers typically indicate that the best beverage for hydration and thirst quenching is water. Water is essential to life, and proper hydration is necessary for maintaining proper physiologic homeostasis in the human body. However, most people, including, but not limited to, children do not drink the recommended daily amount of water.

Many of the hydration beverage products that are currently marketed have flavors that mask the taste of water. As a result, consumers may not feel that many of these beverage products provide sufficient hydration or quench their thirst.

### SUMMARY

In one aspect of the disclosure, a process is provided. The process composes a solution that includes water and organic maltodextrin such that the organic maltodextrin is soluble in the water. Further, the process adds an organic compliant color to the solution such that eight fluid ounces of the solution is less than or equal to two and one half calories, and at least ninety five percent of a dry weight of the solution is organic substances. The organic compliant color includes at least one antioxidant. Finally, the process pasteurizes the solution.

In another aspect, a process is provided. The process composes a solution that includes water and organic maltodextrin such that the organic maltodextrin is soluble in the water. Further, the process adds an organic color to the solution such that the solution is less than or equal to two and one half calories in eight fluid ounces of the solution. The organic color includes at least one antioxidant. Finally, the process pasteurizes the solution.

In yet another aspect, a process is provided. The process composes a solution that includes water and an organic binder such that the organic binder is soluble in the water. Further, the process adds an organic compliant color to the solution such that the solution is less than or equal to twenty five calories in eight fluid ounces of the solution, and at least ninety five percent of a dry weight of the solution is organic substances. Finally, the process pasteurizes the solution.

In another aspect, a process is provided. The process composes a solution that includes water and an organic binder such that the organic binder is soluble in the water. Further, the process adds an organic color to the solution such that the solution is less than or equal to twenty five calories in eight fluid ounces of the solution. Finally, the process pasteurizes the solution.

In yet another aspect, a process is provided. The process composes a solution that includes water and an organic binder such that the organic binder is soluble in the water. Further, the process pasteurizes the solution.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a process that may be utilized to provide a water beverage.

FIG. 2 illustrates another process that may be utilized to provide a water beverage.

FIG. 3 illustrates yet another process that may be utilized to provide a water beverage.

FIG. 4 illustrates another process that may be utilized to provide a water beverage.

FIG. 5 illustrates another process that may be utilized to provide a water beverage.

### DETAILED DESCRIPTION

A process that produces a water beverage is provided. In one embodiment, a color is added to a solution to provide a water beverage that makes the water more appealing to consumers. As a result, more consumers may come closer to meeting the recommended daily amounts of water intake. Further, in one embodiment, the water beverage does not have preservatives. In another embodiment, the water beverage may include one or more antioxidants to help improve the health of the consumer. In yet another embodiment, a natural flavor is provided without flavor extract enhancement to the water beverage.

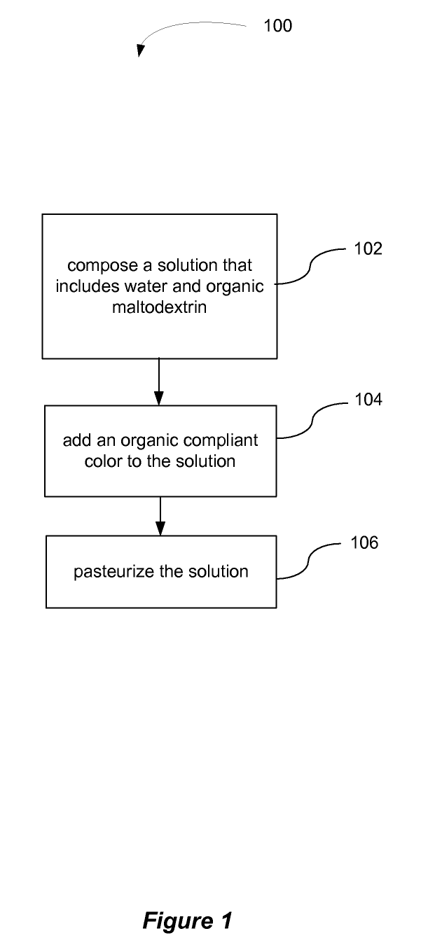

FIG. 1 illustrates a process 100 that may be utilized to provide a water beverage. At a process block 102, the process 100 composes a solution that includes water and organic maltodextrin such that the organic maltodextrin is soluble in the water. The water may be a variety of different types of water. For example, the water may be municipal water source, spring water, mineral water, carbonated water, vapor distilled water, purified water, reverse osmosis water, artesian water, or any type of drinking water. Reverse osmosis water is a filtration process that produces purified water by utilizing a pressurized membrane system. Vapor distilled water is distilled water that has had its impurities removed through distillation, which is boiling of water and condensing the steam into a clean container. Purified water is water that is physically processed to remove impurities. Further, the term organic is intended herein to refer to substances produced without conventional pesticides, artificial fertilizers, human waste, or sewage sludge and processed without ionizing radiation or food additives. Accordingly, the organic maltodextrin is produced and processed as an organic substance.

Further, at a process block 104, the process 100 adds an organic compliant color to the solution such that the solution is less than or equal to two and one half calories in eight fluid ounces of the solution, and at least ninety five percent of a dry weight of the solution is organic substances. The organic compliant color includes at least one antioxidant. The term organic compliant is intended herein to refer to a substance that is not organic, but that may be utilized with organic substances without necessarily removing the organic designation from the overall product. For example, an organic compliant color may exclude certain synthetic, nonsynthetic, nonagriculatural, and nonorganic agricultural substances, but may not be organic itself. In one embodiment, at least ninety five percent of the dry weight of the resulting solution, i.e., the weight without the water, is organic substances. As a result, the resulting solution may be considered organic. For example, a solution that has a dry weight that ninety five percent organic maltodextrin and five percent natural color may be designated as organic. In addition, eight fluid ounces of the solution are less than or equal to two and one half calories in of the solution.

In another embodiment, at least seventy percent of the dry weight of the resulting solution, i.e., the weight without the water, is organic substances. As a result, the resulting solution may be considered made with organic. This variation may be utilized by any of the processes described herein.

In yet another embodiment, one hundred percent of the dry weight of the resulting solution, i.e., the weight without the water, is organic substances. The color also includes one hundred percent ingredients. As a result, the resulting solution may be considered one hundred percent organic. This variation may be utilized by any of the processes described herein.

In addition, at a process block 106, the process pasteurizes the solution. In one embodiment, the pasteurization of the solution is performed for a maximum time period of sixty seconds at a temperature of at least two hundred degrees Farenheit.

In another embodiment, the process 100 fills the solution, after the pasteurizing, at a temperature of at least one hundred eighty five degrees Farenheit into a container that withstands a temperature of at least one hundred eighty five degrees Fahrenheit. The container may be composed from Polyethylene terephthalate plastics, glass, or other container types. The container may alternatively be composed form a combination of such materials.

In yet another embodiment, the process 100 seals the container with a cap inverted for a maximum time period of sixty seconds to eradicate any potential microorganism in the cap. Further, the process 100 may cool the container, after the sealing, through a water bath. Other types of cooling mechanisms may be utilized.

The organic compliant color may be a liquid (including syrup), solid, or powder form. The organic compliant color is soluble in water. The organic compliant color may be either natural or at least seventy percent organic. The at least one antioxidant in the organic compliant color may contain vitamins and minerals.

In one embodiment, alternatives may be utilized for the organic maltodextrin. For example, rice dextrin or tapioca flour/starch that is at least seventy percent organic may be utilized. Alternatively, any other substances from the dextrins may be utilized. Dextrins are a group of low molecular weight carbohydrates produced by the hydrolysis of starch.

A binder is a food additive that acts as a binding agent, carrier, water soluble glue, or thickening agent. Alternatively other types of binders may be utilized. The binder is at least seventy percent organic. Further, the binder may have levels of dextrose content ranging from one to twenty five dextrose equivalents. In addition, the binder is soluble in water.

In one embodiment, the binder is a fiber source. In yet another embodiment, the process 100 may add a fiber source to the solution. The fiber source may be a liquid (including syrup), solid, or powder form. In one embodiment, the fiber source is soluble in water. The fiber source may be not organic, organic compliant, or at least seventy percent organic. The fiber source may have levels of fiber ranging from twenty five milligrams to two grams. In one embodiment, the fiber source is added to the solution when the binder is not a fiber source. In another embodiment, the fiber source is added to the solution as an additional fiber source when the binder is a fiber source.

In one embodiment, the process 100 may add at least one electrolyte to the solution. The electrolyte may be a liquid (including syrup), solid, or powder form. The electrolyte may be from any class including Sodium, Potassium, Chloride, Magnesium, Phosphorus, Manganese, Zinc, Boron, Calcium, Copper, Fluoride, Iodine, Iron, Molybdenum, Nickel, Selenium, etc. In one embodiment, the electrolyte is soluble in water. In another embodiment, the electrolyte is organic compliant. In another embodiment, the electrolyte is at least seventy percent organic.

In another embodiment, the process 100 may add a stimulant to the solution. The stimulant may be a liquid (including syrup), solid, or powder form. The stimulant may be caffeine, guarana, yerba mate, or other natural stimulants. In one embodiment, the stimulant is organic compliant. In another embodiment, the stimulant is seventy percent organic.

In yet another embodiment, the solution is maintained at a pH level to prevent microbiological spoilage of the water beverage. In one embodiment, the organic compliant color has a pH in the range of three and one half and four and sixth tenths. In another embodiment, the process 100 acidifies the organic compliant color so that the organic compliant color has a pH in the range of three and one half and four and sixth tenths. In yet another embodiment, the process 100 acidifies the solution so that the solution has a pH in the range of three and one half and four and sixth tenths. In one embodiment, an optimal pH is four and two tenths.

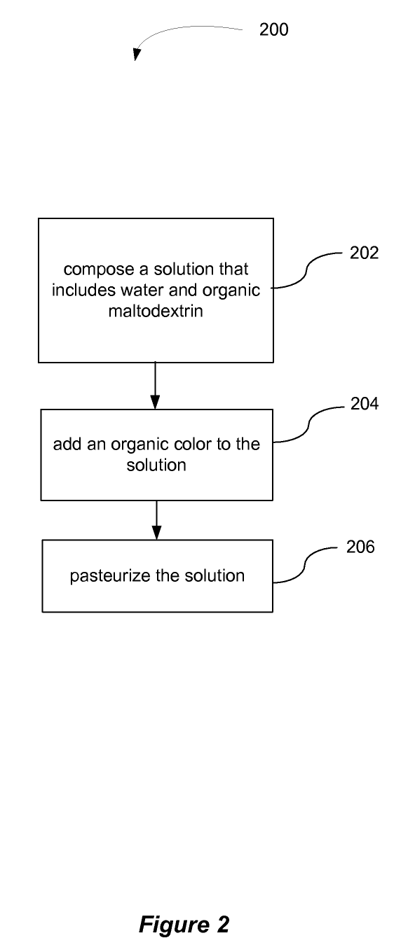

FIG. 2 illustrates another process 200 that may be utilized to provide a water beverage. At a process block 202, the process 200 composes a solution that includes water and organic maltodextrin such that the organic maltodextrin is soluble in the water. Further, at a process block 204, the process 200 adds an organic color to the solution such that eight fluid ounces of the solution has less than or equal to two and one half calories in eight fluid ounces of the solution. The organic color includes at least one antioxidant. In addition, at a process block 206, the process 200 pasteurizes the solution.

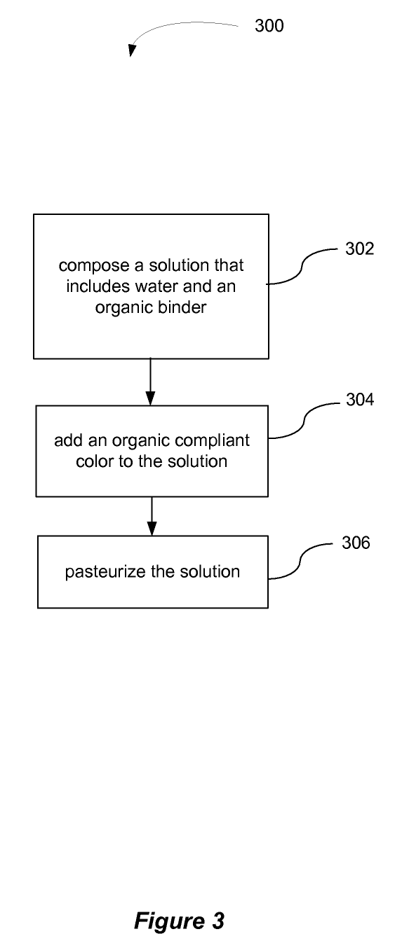

FIG. 3 illustrates yet another process 300 that may be utilized to provide a water beverage. At a process block 302, the process 300 composes a solution that includes water and an organic binder such that the organic binder is soluble in the water. Further, at a process block 304, the process 300 adds an organic compliant color to the solution such that eight fluid ounces of the solution has less than or equal to twenty five calories, and at least ninety five percent of a dry weight of the solution is organic substances. In addition, at a process block 306, the process 300 pasteurizes the solution.

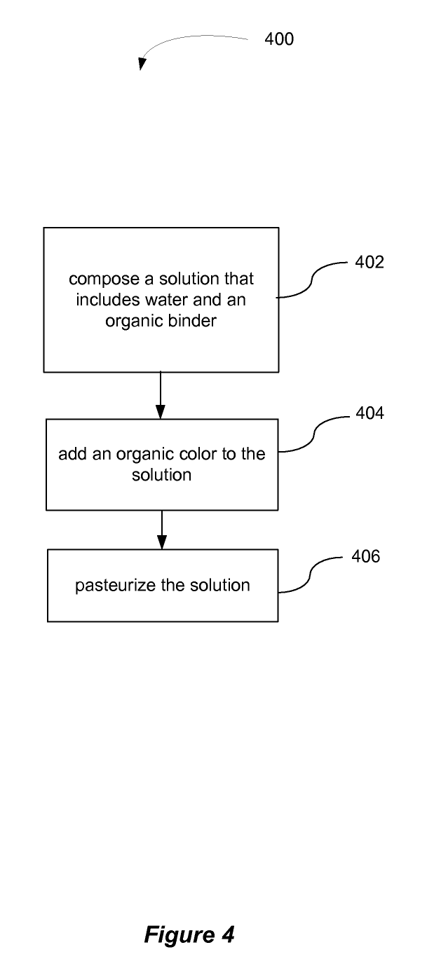

FIG. 4 illustrates another process 400 that may be utilized to provide a water beverage. At a process block 402, the process 400 composes a solution that includes water and an organic binder such that the organic binder is soluble in the water. In addition, at a process block 404, the process 400 adds an organic color to the solution such that eight fluid ounces of the solution is less than or equal to twenty five calories. Finally, the process 400 pasteurizes the solution.

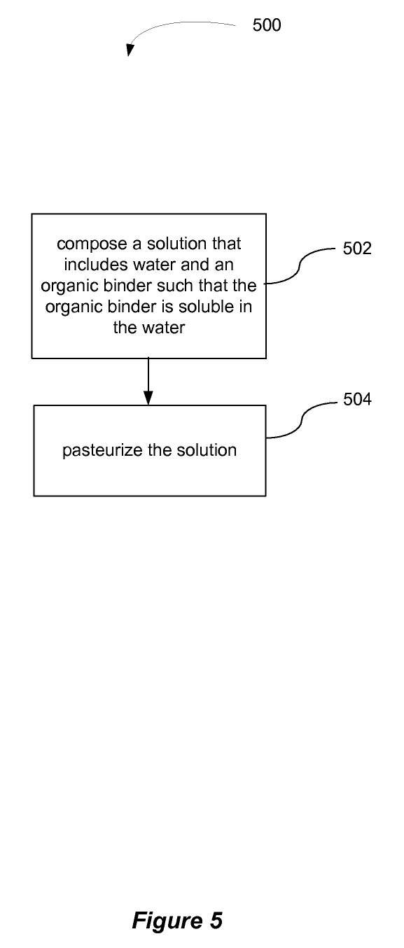

FIG. 5 illustrates another process 500 that may be utilized to provide a water beverage. At a process block 502, the process 500 composes a solution that includes water and an organic binder such that the organic binder is soluble in the water. Further, at a process block 504, the process 500 pasteurizes the solution. In another embodiment, the various calorie restrictions described in the other configurations herein may also be utilized with the process 500. An example of the organic binder is organic maltodextrin. Alternatively, any other substances from the dextrins may be utilized. In one embodiment, the binder may be a substance that is at least seventy percent organic may be utilized. Alternatively, any other substances from the dextrins may be utilized.

Any of the variations described herein may be applicable to any of the processes also described herein. For example, the various pasteurization techniques may be applicable to any of the processes described herein.

It is understood that the process described herein may also be applied with other configurations. Those skilled in the art will appreciate that the various adaptations and modifications of the embodiments of this process may be configured without departing from the scope and spirit of the present process. Therefore, it is to be understood that, within the scope of the appended claims, the present process may be practiced other than as specifically described herein.

We claim:

1. A method comprising:
composing a solution that includes water and organic maltodextrin such that the organic maltodextrin is soluble in the water;
adding an organic compliant color to the solution such that eight fluid ounces of the solution is less than or equal to two and one half calories, and at least ninety five percent of a dry weight of the solution is organic substances, the organic compliant color including at least one antioxidant; and
pasteurizing the solution.

2. The method of claim 1, wherein the pasteurizing the solution is performed for a maximum time period of sixty seconds at a temperature of at least two hundred degrees Fahrenheit.

3. The method of claim 1, further comprising filling the solution, after the pasteurizing, at a temperature of at least one hundred eighty five degrees Fahrenheit into a container that withstands a temperature of at least one hundred eighty five degrees Fahrenheit.

4. The method of claim 3, wherein container is composed of a polyethylene terephthalate plastic.

5. The method of claim 1, further comprising sealing the container with a cap inverted for a maximum time period of sixty seconds to eradicate any potential microorganism in the cap.

6. The method of claim 5, further comprising cooling the container, after the sealing, through a water bath.

7. The method of claim 1, wherein the water is reverse osmosis water.

8. The method of claim 1, wherein the water is vapor distilled water.

9. The method of claim 1, wherein the organic compliant color has a pH in the range of three and one half and four and sixth tenths.

10. The method of claim 1, further comprising acidifying the organic compliant color so that the organic compliant color has a pH in the range of three and one half and four and sixth tenths.

11. The method of claim 1, further comprising acidifying the solution so that the solution has a pH in the range of three and one half and four and sixth tenths.

12. The method of claim 1, further comprising adding a stimulant to the solution.

13. A method comprising:
composing a solution that includes water and organic maltodextrin such that the organic maltodextrin is soluble in the water;
adding an organic color to the solution such that the solution is less than or equal to two and one half calories in eight fluid ounces of the solution, the organic color including at least one antioxidant; and
pasteurizing the solution.

14. The method of claim 13, wherein the pasteurizing the solution is performed for a maximum time period of sixty seconds at a temperature of at least two hundred degrees Fahrenheit.

15. The method of claim 13, further comprising filing solution, after the pasteurizing, at a temperature of at least one hundred eighty five degrees Fahrenheit into a container that can withstand a temperature of at least one hundred eighty five degrees Fahrenheit.

16. A method comprising:
composing a solution that includes water and an organic binder such that the organic binder is soluble in the water;
adding an organic compliant color to the solution such that the solution is less than or equal to twenty five calories in eight fluid ounces of the solution, and at least ninety five percent of a dry weight of the solution is organic substances; and
pasteurizing the solution.

17. The method of claim 16, wherein the organic compliant color includes at least one antioxidant.

18. The method of claim 16, wherein the organic binder is maltodextrin.

19. The method of claim 16, wherein the organic binder is an organic fiber source.

20. A method comprising:
composing a solution that includes water and an organic binder such that the organic binder is soluble in the water;
adding an organic color to the solution such that the solution is less than or equal to twenty five calories in eight fluid ounces of the solution; and
pasteurizing the solution.

21. The method of claim 20, wherein the organic color includes at least one antioxidant.

22. The method of claim 20, wherein the organic binder is maltodextrin.

23. The method of claim 20, wherein the organic binder is an organic fiber source.

24. A method comprising:
composing a solution that includes water and an organic binder such that the organic binder is soluble in the water; and
pasteurizing the solution.
